(19) United States
(12) Patent Application Publication
(10) Pub. No.: US 2009/0105195 A1
(43) Pub. Date: Apr. 23, 2009

(54) COMPOSITION COMPRISING MICROBICIDAL ACTIVE INGREDIENTS

(76) Inventor: Chris O'Brien, Sacramento, CA (US)

Correspondence Address: Jay M. Schloff;Intellipex PLLC, Suite 245, 30200 Telegraph Road, Bingham Farms, MI, 48025, US

(21) Appl. No.: 12/252,971

(22) Filed: Oct. 16, 2008

Related U.S. Application Data
(60) Provisional application No. 60/980,516, filed on Oct. 17, 2007.

(51) Int. Cl. A01N 43/16; A01N 37/06; A01N 55/10; A01P 1/00

(52) U.S. Cl. 514/56; 514/558; 514/560; 514/63

(57) ABSTRACT

An antimicrobial composition having a broad-spectrum activity against microorganisms is provided. The antimicrobial composition includes about 0.1 to about 10 percent by weight of a polyurethane polymer of total weight of the antimicrobial composition. The polyurethane polymer is selected from the group consisting of polyolprepolymer and β-Cyclodextrin-polyurethane polymer. The antimicrobial composition further includes about 0.01 to about 5 percent by weight of at least one antiseptic agent of the total weight of the antimicrobial composition. Furthermore, the antimicrobial composition includes at least one microbicidal agent. In addition, the antimicrobial composition includes a pharmaceutically acceptable excipient system.

### CROSS REFERENCE TO RELATED APPLICATION

The present invention claims priority under 35 United States Code, section 119, from provisional patent application Ser. No. 60/980,516, filed on Oct. 17, 2007, entitled, “Composition Comprising Microbicidal Active Ingredients”.

### FIELD OF THE INVENTION

The present invention relates to a composition comprising a synergistic combination of different microbicidal active ingredients that together provide chemical compatibility, and broad-spectrum activity against microorganisms and environmental toxins.

### BACKGROUND OF THE INVENTION

Various compositions comprising antimicrobial agents (hereinafter interchangeably referred to as “microbicidal active ingredients”) are available in the prior art for destruction of microorganisms and pathogens that are capable of causing various skin diseases and/or skin infections in a person. Suitable examples of the antimicrobial agents include, but are not limited to, antiseptic agents including antibacterial agents, antiviral agents, and the like; and fatty acids. However, conventional compositions are known for destruction of selective microorganisms and pathogens. Accordingly, the conventional compositions are incapable of exhibiting broad-spectrum activity against varied kind of microorganisms and pathogens, including some potentially hazardous microorganisms, such as Mycobacterium fortuitum, Papillomavirus, Trichophyton species, and the like. Such microorganisms are known to cause infections that may occur in skin, which is damaged during pedicure foot soaks and manicure; after shaving one's legs; after nail salon treatments; during exposure to microorganisms that may be prevalent in gymnasiums and changing rooms; by direct contact with a hand of an infected person; after a skin-to-skin contact with an infected person; or during other similar situations. Persistent effects of the antimicrobial agents are desirable for treatment and prevention of the skin infections caused due to or after the aforementioned conditions. However, the conventional compositions comprising commonly known and/or used antimicrobial agents are incapable of exhibiting the required persistent effects along with good chemical compatibility and reduced skin irritation.

More specifically, various conventional compositions include antiseptics, such as chlorhexidine and benzalkonium salts; and other microbicidal active ingredients, such as sodium lauryl sulfate and fatty acids, for treating and preventing skin infections. These antiseptics have good skin persistence (also referred to as “microbicidal persistence”). However, a prolonged use of the antiseptics is associated with various types of side effects and risks, including deposition of the antiseptics in body tissues. Further, previously known antiseptics, such as triclosan, p-chloro-m-xylenol (PCMX) are prone to undergo systemic absorption causing adverse health consequences, when administered to a person. The foregoing drawback suggests a requirement to reduce the systemic absorption of the antiseptics after administration. The antiseptics have also proved to be ineffective against specific types of microorganisms, such as non-enveloped viruses.

Alternately, some of the microbicidal active ingredients, such as the fatty acids (for example palmitoleic acid), are known to exhibit effective antimicrobial activity against some of the potentially hazardous microorganisms, including the non-enveloped viruses and Mycobacterium fortuitum, which are resistant to most of the antiseptics. However, such microbicidal active ingredients have poor skin persistence, and accordingly, are preferably used only at the time of occurrence of an infection, thereby limiting any extent of utilization thereof. More specifically, the microbicidal active ingredients lose activity for combating with the microorganisms, if applied prior to an infection on skin of a person for prevention purposes (i.e., with time, effectiveness of the microbicidal active ingredients reduces, if applied prior to a direct or indirect entry/attack by the microorganism onto the skin). Although, these microbicidal active ingredients have been proven to be effective intravaginal compositions (in the form of gels) and are suggested for use on the skin, however, there has been a reduction in utilization of compositions comprising the microbicidal active ingredients due to poor skin persistence thereof.

Combinations of a few antiseptics, such as triclosan, with various other microbicidal active ingredients have also been developed. However, such combinations have also exhibited activity against limited number of microorganisms and/or are incapable of exhibiting enhanced skin persistence.

For increasing skin persistence, various delivery systems have been developed for use with the antimicrobial agents. Usually, such delivery systems may utilize liposomes to deliver the antimicrobial agents for enhanced skin persistence. However, such delivery systems cause a slow release of the antimicrobial agents, which results in close contact of the antimicrobial agents with each other and may lead to a reduced efficacy of the antimicrobial agents. Till date, efforts have been made to formulate compositions comprising different types of antimicrobial agents capable of being delivered cutaneously using conventional delivery systems to allow the antimicrobial agents to remain active on the skin for an extended period of time. However, such compositions are incapable of preserving bioactivity (i.e., effect upon a living organism or on a living tissue) of the antimicrobial agents.

Accordingly, various preservative systems have been developed for utilization in the compositions comprising the different types of antimicrobial agents for preservation of bioactivities thereof. In general, the preservative systems may include agents such as sodium lauryl sulfate; parabens; and a combination of cationic, anionic and non-anionic surfactants. However, the agents of the preservative systems are usually employed at concentrations, which cause an overall increase in dose of conventional compositions, to achieve desirable results. Such a requirement increases the risk of occurrence of side effects of various ingredients of the compositions. Further, the agents such as parabens are known to unnecessary build up or deposit in body tissues. Furthermore, the agents, such as sodium lauryl sulfate, often act as skin irritants.

By and large, the previously disclosed compositions are associated with low skin persistence, skin incompatibility and/or incompatibility among various ingredients (including microbicidal active ingredients and inactive ingredients) thereof. More specifically, the previously disclosed compositions are incapable of providing significant microbicidal persistence on skin along with compatibility among the various ingredients thereof; reduced irritation and broad-spectrum activity for an effective destruction of multiple microorganisms. Further, the previously disclosed compositions are incapable of moisturizing and replenishing natural oils lost from skin during pedicures, manicures, rubbing of the skin, sexual intercourse, and the other similar activities.

Accordingly, there exists a need for a composition comprising different microbicidal active ingredients that together provide broad-spectrum activity against multiple microorganisms, while exhibiting good microbicidal persistence and reduced skin irritation caused by the different microbicidal active ingredients. Further, there exists a need for a composition, which is capable of providing compatibility among different microbicidal active ingredients along with providing skin compatibility of the different microbicidal active ingredients on an epidermal portion or a subdermal portion of the skin. Furthermore, there exists a need for a composition which is harmless to a user in terms of causing any adverse effect of different microbicidal active ingredients and may help in moisturizing and replenishing natural oils lost from skin during pedicures, manicures, rubbing of skin, sexual intercourse, and the like. Additionally, there exists a need for a composition, an administration of which helps in reducing systemic absorption of different microbicidal active ingredients and other inactive ingredients (if any), in order to reduce likelihood of occurrence of any health consequences. Moreover, there exists a need for a composition, which is capable of providing enhanced synergistic absorption that one microbicidal active ingredient, or inactive ingredient may cause on another, on intact and compromised epithelium or other tissues. In addition, there exists a need for a composition, which is capable of protecting damaged skin, and is capable of preventing infections in whirlpools, during foot soaks, and in other similar situations.

### SUMMARY OF THE INVENTION

In view of the foregoing disadvantages inherent in the prior art, the general purpose of the present invention is to provide composition active against a broad-spectrum of microorganisms, which includes all the advantages of the prior art, and overcomes the drawbacks inherent therein.

Accordingly, an object of the present invention is to obviate the above and other disadvantages from the existing art by providing broad-spectrum antimicrobial activity and by extending microbicidal persistence, providing skin compatibility, and protecting a user from side effects from microbicidal active ingredients.

It is another object of the present invention to provide a composition that reduces irritation caused from individual microbicidal active and inactive ingredients included therein.

Another object of the present invention is to provide an antimicrobial composition that reduces irritation from environmental toxins on intact or compromised epithelium or other tissues.

Another object of the present invention is to provide an immediate and persistent microbicidal skin barrier and protectant that forms a reservoir system.

Another object of the present invention is to provide a composition having different microbicidal active ingredients, to reduce systemic absorption of individual microbicidal active ingredients and inactive ingredients, and to enhance synergistic absorption that one ingredient may cause on another on intact and compromised epithelium or other tissues.

Another object of the present invention is to provide a composition that maintains compatibility of different microbicidal active ingredients included therein, on epidermis or a subdermal portion of skin.

Another object of the present invention is to provide a podiatric product that protects damaged skin and prevents infections in whirlpools, during foot soaks and in other similar situations.

Yet another object of the present invention is to provide a composition that moisturizes and replenishes natural oils lost from skin, during pedicures, manicures, rubbing of the skin, sexual intercourse and the like.

In light of the above objects, the present invention provides an antimicrobial composition having a broad-spectrum activity against microorganisms. The antimicrobial composition includes about 0.01 to about 10 percent by weight of a polyurethane polymer of total weight of the antimicrobial composition. The polyurethane polymer is selected from the group consisting of polyolprepolymer and β-Cyclodextrin-polyurethane polymer. Further, the antimicrobial composition includes about 0.01 to about 5 percent by weight of at least one antiseptic agent of the total weight of the antimicrobial composition. Furthermore, the antimicrobial composition includes at least one microbicidal agent selected from the group consisting of fatty acids and surfactants. Additionally, the antimicrobial composition includes a pharmaceutically acceptable excipient system.

This together with other embodiments of the present invention, along with the various features of novelty that characterize the present invention, is pointed out with particularity in the claims annexed hereto and form a part of this disclosure. For a better understanding of the present invention, its operating advantages, and the specific objects attained by its uses, reference should be made to the descriptive matter in which there are provided exemplary embodiments of the present invention.

### BRIEF DESCRIPTION OF THE DRAWING

None.

### DETAILED DESCRIPTION OF THE INVENTION

The exemplary embodiments described herein are subject to many variations. It is understood that various omissions and substitutions of equivalents are contemplated as circumstances may suggest or render expedient, but these are intended to cover the application or implementation without departing from the spirit or scope of the present invention. All ranges disclosed herein are inclusive and combinable.

As used herein, the term “synergistic” refers to additive effects of different ingredients (including microbicidal active and inactive ingredients) when combined with each other.

As used herein, the term “composition” refers to creams, lotions, sprays, gels, spray lotions, emulsions, cream gels, ointments, solutions, or any other suitable topical dosage form. The composition may be either in a liquid form or a semisolid form.

As used herein, the term “microbicidal” refers to ingredients, which are capable of killing (or destructing) various microorganisms including bacteria, viruses, fungi and prions. Additionally, the term may also refer to the ingredients, which are capable of destroying environmental toxins that may be hazardous for human beings in terms of causing infections.

As used herein, the term “microorganisms” refers to a disease-producing (or disease-causing) agent. The term may also be referred to as “microbes”. Further, the term may also be construed to refer to various pathogens.

As used herein, the term “compromised epithelium” refers to any damage caused to skin, by any object; due to shaving; during skin-to-skin contact; during pedicures, manicures, and such similar activities.

The present invention provides a composition comprising a plurality of microbicidal active ingredients (hereinafter referred to as “microbicidal active ingredients”) that produce a synergistic effect against multiple microorganisms. Hereinafter, the composition may interchangeably be referred to as an “antimicrobial composition”. The antimicrobial composition is in the form of a skin barrier and protectant that uses a dermal polymer reservoir system for persistent activity, minimized skin irritation, and reduced systemic absorption on intact and compromised epithelium. The antimicrobial composition of the present invention may be administered topically to skin of a person. Further, the antimicrobial composition may be administered intravaginally.

According to an embodiment of the present invention, the antimicrobial composition having a broad-spectrum activity against microorganisms, includes a polyurethane polymer; at least one antiseptic agent; at least one microbicidal agent selected from the group consisting of fatty acids and surfactants; a pharmaceutically acceptable excipient system; at least one polysaccharide (hereinafter referred to as “polysaccharides”); and one or more essential oils (hereinafter referred to as “essential oils”).

The antimicrobial composition includes the polyurethane polymer in an amount ranging from about 0.01 to about 10 percent by weight of total weight of the antimicrobial composition. The term, “total weight,” as used herein may refer to 100 percent by weight of the antimicrobial composition. The polyurethane polymer serves as a reservoir to reduce skin irritation, while also providing microbicidal persistence and immediate effects, of the antimicrobial composition. Further, the polyurethane polymer provides chemical compatibility among various ingredients of the antimicrobial composition. The polyurethane polymer may be selected from the group consisting of polyolprepolymer (copolymer), and β-Cyclodextrin-polyurethane (β-CDPU) polymer. According to a preferred embodiment of the present invention, polyolprepolymer is used in the antimicrobial composition to enhance microbicidal efficacy, and cationic and anionic ingredient compatibility, while reducing side effects of the antimicrobial composition.

Further, the use of polyolprepolymer allows the antimicrobial composition to exhibit persistent microbicidal activity with reduced systemic absorption and reduced irritation with regard to the various ingredients, such as the surfactants and the fatty acids. The polyolprepolymer may be selected from the group consisting of polyolprepolymer-2 (PP-2), polyolprepolymer-14 and polyolprepolymer-15. According to an embodiment of the present invention, the antimicrobial composition includes PP-2 in an amount ranging from about 0.01 to about 10 percent by weight of the total weight of the antimicrobial composition.

PP-2 is a urethane compound that may be prepared by reacting approximately two moles of a hydroxy terminated linear alkylene or polyalkylene glycol or polyether with approximately one mole of a monomeric organic diisocyanate. PP-2 is capable of penetrating stratum corneum, i.e., the outermost layer of epidermis of skin, but is incapable of migrating any further into the skin. Accordingly, PP-2 tends to form a “reservoir” within the skin, and subsequently, allows for a slow release of the various ingredients dissolved therein, for a prolonged effect without affecting efficacy of any ingredient.

The antimicrobial composition of the present invention includes the at least one antiseptic agent in an amount ranging from about 0.01 to about 5 percent by weight of the total weight of the antimicrobial composition. Suitable examples of the at least one antiseptic agent include, but are not limited to, chlorophenols (o-, m-, p-), 2,4-dichlorophenol, p-nitrophenol, picric acid, xylenol, p-chloro-m-xylenol (PCMX), pyrocatechol, resorcinol, cresols (o-, m-, p-); p-chloro-m-cresol, 4-n-hexyl-resorcinol, pyrogallol, phloroglucin, carvacrol, thymol, p-chlorothymol, o-phenyl phenol, o-benzyl phenol, p-chloro-o-benzyl phenol, phenol, 4-ethylphenol, 4-phenol sulfonic acid, bisguanidines (such as chlorhexidine digluconate), diphenyl compounds, benzyl alcohols, benzalkonium salts (such as benzalkonium chloride (BZK)), trihalocarbanilides, quaternary ammonium compounds, ethoxylated phenols, triclosan and heparin. In a preferred embodiment, the antimicrobial composition may include BZK in an amount ranging from about 0.01 to about 5 percent by weight of the total weight of the antimicrobial composition. BZK shows activity against gram negative pathogens. Use of BZK with PP-2 augments spectrum of various antiviral and antimycobacterial agents.

As described earlier, the antimicrobial composition further includes at least one microbicidal agent selected from the group consisting of surfactants, and fatty acids.

The antimicrobial composition may include the surfactants in an amount ranging from about 0.001 to about 10 percent by weight of the total weight of the antimicrobial composition. The surfactants are used in the antimicrobial composition to broaden the microbiocidal spectrum against multiple microorganisms. The surfactants may be selected from the group consisting of cationic surfactants, such as, quaternary ammonium compounds; anionic surfactants, such as, sodium lauryl sulfate (SLS), docusate sodium; chemical precursors thereof; and combinations thereof. SLS is effective against Papillomavirus and gram positive microorganisms. In a preferred embodiment, the antimicrobial composition may include SLS in an amount ranging from about 0.001 to about 10 percent by weight of the total weight of the antimicrobial composition.

The fatty acids may be present in an amount ranging from about 0.001 to about 25 percent by weight of the total weight of the antimicrobial composition. The fatty acids help in broadening microbicidal spectrum of the antimicrobial composition, and may be selected from medium-chain saturated and long-chain unsaturated fatty acids. Short chain fatty acids may also be incorporated in the antimicrobial composition for improved efficacy against gram negative microorganisms (i.e., gram negative bacteria). Specifically, the saturated and unsaturated fatty acids help in replenishing natural skin. Further, the saturated and unsaturated fatty acids raise immunity to Mycobacterium sp. and other bacteria such as Trichophyton sp.; fungi; and Herpes Simplex Virus (HSV) and other enveloped viruses, after activities (such as a pedicure) that may damage the epidermis and remove oils thereof. Furthermore, the fatty acids provide mild efficacy against non-enveloped viruses.

The fatty acids are the only ingredients with good efficacy against Mycobacterium sp. but very weak against gram negative microorganisms. Accordingly, the use of the fatty acids with the surfactants, such as sodium lauryl sulfate, and BZK provides enhanced effects against Mycobacterium sp., Papillomavirus, and gram positive microorganisms and gram negative microorganisms.

Each fatty acid of the fatty acids may be selected from the group consisting of palmitoleic acid, capric acid, caprylic acid, lauric acid, myristic acid, stearic acid, palmitic acid, oleic acid, linoleic acid, linolenic acid, arachidonic acid and monolaurin. Specifically, C-10 fatty acids are efficacious against Mycobacteria sp. In addition, coconut oil, macadamia oil, and the like, may be used in the antimicrobial composition to obtain antimicrobial effects from fatty acids as present in such oils.

The pharmaceutically acceptable excipient system, for use in the antimicrobial composition, includes a solvent selected from the group consisting of water, lower alcohols having one to six carbon atoms, polyols, glycols, sorbitol and combinations thereof. Specific examples of the solvent used in the antimicrobial composition include, but are not limited to, water, ethanol, glycerol, butylene glycol, isoprene glycol, polypropylene glycol (or propylene glycol), polyethylene glycols (such as polyethylene glycol 8; PEG-8), sorbitol, and combinations thereof. In a preferred embodiment of the present invention, propylene glycol in an amount ranging from about 0.01 to about 30 percent by weight of the total weight of the antimicrobial composition is used. Propylene glycol is safe to use with latex material (material used in condoms), serves as a humectant, and does not cause irritation to the skin. Polyolprepolymer when used with propylene glycol in appropriate percentages allows for compatibility of anionic and cationic microbicidal agents (such as surfactants and quaternary ammonium compound BZK) to remain compatible with each other.

In another embodiment, the antimicrobial composition may include an emulsion as the solvent. Specifically, Emulgade® CM (obtained from Henkel), which is an oil-in-water emulsion, may be used alone or in combination with the above specified types of solvent in the antimicrobial composition. More specifically, Emulgade® CM may be present in an amount ranging from about 0.001 to about 10 percent by weight of the total weight of the antimicrobial composition.

The pharmaceutically acceptable excipient system may further include about 0.01 to about 10 percent by weight of a chelating agent of the total weight of the antimicrobial composition. More specifically, the pharmaceutically acceptable excipient system may further include about 0.01 to about 5 percent by weight of the chelating agent of the total weight of the antimicrobial composition. The chelating agent may be selected from the group consisting of ethylenediamine tetraacetic acid (EDTA), citric acid, gluconic acid, B-cyclodextran, hydroxyethylenediamine tetraacetic acid, derivatives, salts and mixtures thereof. In a preferred embodiment, the antimicrobial composition may include EDTA in an amount ranging from about 0.01 to about 5 percent by weight of the total weight of the antimicrobial composition.

Furthermore, the pharmaceutically acceptable excipient system may include about 0.01 to about 5 percent by weight of a hydrotrope of the total weight of the antimicrobial composition. As used herein, the term “hydrotrope” refers to an ingredient that has an ability to enhance water solubility of other ingredients. A suitable hydrotrope used in the antimicrobial composition is a short-chain alkyl aryl sulfonate. The hydrotrope may be selected from the group consisting of sodium cumene sulfonate, ammonium cumene sulfonate, ammonium xylene sulfonate, potassium toluene sulfonate, sodium toluene sulfonate, sodium xylene sulfonate (SXS), toluene sulfonic acid, xylene sulfonic acid, sodium polynaphthalene sulfonate, sodium polystyrene sulfonate, sodium methyl naphthalene sulfonate, sodium camphor sulfonate, and disodium succinate. In a preferred embodiment, the antimicrobial composition may include sodium polystyrene sulfonate in an amount ranging from about 0.01 to about 5 percent by weight of the total weight of the antimicrobial composition. Sodium polystyrene sulfonate with EDTA provides excellent broad-spectrum antimicrobial composition.

In addition, the pharmaceutically acceptable excipient system may include at least one of emollients, tonicity modifiers, thickening agents and gelling agents.

Examples of the emollients for use in the antimicrobial composition may include, but are not limited to, isopropyl isostearate, isopropyl palmitate, isopropyl myristate and ethylhexyl palmitate. It should be understood that one or more emollients may be used in the antimicrobial composition, as desired. The type and amount of the one or more emollients may be selected by one skilled in the art using known techniques.

Examples of the tonicity modifiers for use in the antimicrobial composition may include, but are not limited to, salts (for example, sodium chloride or potassium chloride), and sugars (for example, mannitol, dextrose, sucrose, or trehalose). The tonicity modifiers help to adjust a hypotonic solution of the antimicrobial composition for forming an isotonic solution, so that the antimicrobial composition, when in solution, is physiologically compatible with cells of body tissue of a user or a patient. It should be understood that one or more tonicity modifiers may be used in the antimicrobial composition, as desired. The type and amount of the one or more tonicity modifiers may be selected by one skilled in the art using known techniques.

Examples of the thickening agents for use in the antimicrobial composition include, but are not limited to, polysaccharide biopolymers, such as xanthan gum, guar gum, alginates or modified celluloses; and synthetic polymers, such as polyacrylics. It should be understood that one or more thickening agents may be used in the antimicrobial composition, as desired. The type and amount of the one or more thickening agents may be selected by one skilled in the art using known techniques.

Examples of the gelling agents for use in the antimicrobial composition include, but are not limited to, natural gums, cellulose derivatives and starch derivatives. Synthetic polymers having gelling properties, which may be used in the present invention, include carboxyvinyl polymers (carbomers). It should be understood that one or more gelling agents may be used in the antimicrobial composition, as desired. The type and amount of the one or more gelling agents may be selected by one skilled in the art using known techniques.

Moreover, the pharmaceutically acceptable excipient system may include at least one of buffering agents, pH adjusting agents, emulsifiers and wetting agents.

The buffering agents refer to agents that may be used to adjust the pH of the antimicrobial composition. The buffering agents used in the antimicrobial composition include alkali metal hydroxides, carbonates, sesquicarbonates, borates, silicates, phosphates, iridazole, and mixtures thereof. Specific buffering agents include monosodium phosphate, trisodium phosphate, sodium hydroxide, potassium hydroxide, alkali metal carbonate salts, sodium carbonate, imidazole, pyrophosphate salts, citric acid, and sodium citrate. It should be understood that one or more buffering agents may be used in the antimicrobial composition, as desired. The type and amount of the one or more buffering agents may be selected by one skilled in the art using known techniques.

Examples of preferred classes of the pH adjusting agents are mineral acids and bases. Non-limiting examples include hydrochloric acid, nitric acid, phosphoric acid, sulfuric acid, and the like. The identity of the pH adjusting agents is not limited and any pH adjusting agent known in the art, alone or in combination, may be used. According to one embodiment of the present inventions, the pH of the antimicrobial composition may be adjusted in a range of about 4 to about 5.5.

The emulsifiers may be present in a quantity sufficient to combine water-soluble and non-water-soluble phases of the antimicrobial composition of the present invention. The emulsifiers may comprise at least one of a mixture of mono- and di-stearate esters of polyoxyethylene and free polyethylene oxide, partial esters of lauric, palmitic, stearic, and oleic acids and hexitol anhydrides. It should be understood that one or more emulsifiers may be used in the antimicrobial composition, as desired. The type and amount of the one or more emulsifiers may be selected by one skilled in the art using known techniques.

Suitable examples of the wetting agents for use in the antimicrobial composition include, but are not limited to, gelatin, casein, lecithin (phosphatides), gum acacia, cholesterol, tragacanth, stearic acid, benzalkonium chloride, calcium stearate, glycerol monostearate, cetostearyl alcohol, cetomacrogol emulsifying wax, sorbitan esters, polyoxyethylene alkyl ethers (e.g., macrogol ethers such as cetomacrogol 1000), polyoxyethylene castor oil derivatives, polyoxyethylene sorbitan fatty acid esters, polyethylene glycols, polyoxyethylene stearates, colloidal silicon dioxide, phosphates, sodium dodecyl sulfate, carboxymethyl cellulose calcium, carboxymethyl cellulose sodium, methylcellulose, hydroxyethyl cellulose, hydroxy propyl cellulose, hydroxypropyl methylcellulose phthlate, noncrystalline cellulose, magnesium aluminum silicate, triethanolamine, polyvinyl alcohol, and polyvinyl pyrrolidone (PVP). It should be understood that one or more wetting agents may be used in the antimicrobial composition, as desired. The type and amount of the one or more wetting agents may be selected by one skilled in the art using known techniques.

The pharmaceutically acceptable excipient system may also include a preservative. Examples of the preservative for use in the antimicrobial composition include, but are not limited to, imidazolyl urea and a complex of propylene glycol, phenoxyethanol, chlorphenesin, ethyl paraben, propyl paraben, butyl paraben, isobutyl paraben and methyl paraben. It should be understood that one or more preservatives may be used in the antimicrobial composition, as desired. The type and amount of the one or more preservatives may be selected by one skilled in the art using known techniques.

Additionally, the pharmaceutically acceptable excipient system may include an antioxidant that helps in preventing oxidation of the various ingredients of the antimicrobial composition. The antioxidant may be selected from propylene glycol, propyl gallate and citric acid. It should be understood that one or more antioxidants may be used in the antimicrobial composition, as desired. The type and amount of the one or more antioxidants may be selected by one skilled in the art using known techniques.

Based on the foregoing, it should be understood that the ingredients as specified in the pharmaceutically acceptable excipient system includes solvents as the essential pharmaceutically acceptable excipient. Further, the antimicrobial composition may include pH adjusting agents, buffering agents, hydrotropes, emulsifiers, antioxidants, emollients, wetting agents, tonicity modifiers, preservatives, thickening agents, chelating agents and gelling agents, as optional pharmaceutically acceptable excipients. As used herein, the term “pharmaceutically acceptable excipient” refers to any ingredient/compound, which preserves or does not alter the activity of the microbicidal active ingredients, and does not impart any deleterious or untoward effect on a subject (animal or human beings) after administration. Further, the term encompasses reference to inert substances that may be used as carriers, diluents or vehicles for a microbicidal active ingredient of the antimicrobial composition.

The antimicrobial composition may also include an essential oil to help replenishing skin. The essential oil may be present in an amount ranging from about 0.001 to about 1 percent by weight of the total weight of the antimicrobial composition. Suitable essential oils include Tea tree oil, Lemongrass oil, and the like. It should be understood that one or more essential oils may be used in the antimicrobial composition, as desired. The type and amount of the one or more essential oils may be selected by one skilled in the art using known techniques.

The polysaccharides may be present in an amount ranging from about 0.01 to about 5 percent by weight of the total weight of the antimicrobial composition. The polysaccharides help in broadening the microbiocidal spectrum of the antimicrobial composition. The polysaccharides may be selected from natural polysaccharides and synthetic polysaccharides. Suitable examples include, but are not limited to, carrageenan (for example, lambda carrageenan), and chitosan. In a preferred embodiment, the antimicrobial composition may include carrageenan in an amount ranging from about 0.01 to about 5 percent by weight of the total weight of the antimicrobial composition.

SLS, sodium polystyrene sulfonate and carrageenan show activity against enveloped and non-enveloped viruses but are not effective against gram negative microorganisms. However, a combination of SLS, sodium polystyrene sulfonate and carrageenan when used with the cationic surfactants, propylene glycol and PP-2, provides activity against gram negative microorganisms. Further, the cationic surfactants, the anionic surfactants, the fatty acids, the one or more essential oils provide broad spectrum activity against gram positive microorganisms, gram negative microorganisms, Mycobacterium sp., fungus and viruses.

The antimicrobial composition may further include a skin protectant. More specifically, the skin protectant may be present in an amount of about 1 percent by weight of the total weight of the antimicrobial composition. Suitable skin protectants include mixtures of homologous liquid methylsiloxane and silica gel. Examples of such skin protectants include dimethicone, cyclomethicone, and the like. According to a preferred embodiment of the invention, the presence of dimethicone with the polyolprepolymer in the antimicrobial composition serves to increase the efficacy of the antimicrobial composition, while also reducing the side effects of the various ingredients of the antimicrobial composition.

Optionally, the antimicrobial composition of the present invention may include allantoin to further improve the efficacy thereof.

The antimicrobial composition may further include a colorant, such as Bright Blue, also referred to as FD&C (Federal Food, Drug, and Cosmetic Act) Blue No. 1 Solution. Furthermore, the antimicrobial composition may have a fragrance due to the presence of some of the aforementioned ingredients, such as the essential oil. Alternately, an agent may be added to the antimicrobial composition for providing a specific fragrance, without altering properties of the antimicrobial composition.

The antimicrobial composition of the present invention may be prepared by various conventional methods available in the prior art.

Below described are non-limiting examples of the antimicrobial composition of the present invention. Further, synergistic activity of the different ingredients of the antimicrobial composition has been confirmed using standard laboratory techniques, as described in the non-limiting examples below.

### EXAMPLE 1

Cells of pre-cultured strain Escherichia Coli (E. coli) ATCC 8739 (obtained from the American Type Culture Collection (ATCC), Manassas, Va.) were grown for 24 hours at 35° C. The culture was serially diluted with saline to obtain a solution with a final concentration of 1000 per milliliter (1000/ml) approximately. A volume of 9 ml from the final diluted culture solution was dispatched in 4 different test tubes. In each test tube, 1 ml of 4 different exemplary antimicrobial compositions, referred to as “1A”, “1B”, “1C” and “1D”, which had been shaken for 30 minutes, were added to form suspensions. The suspensions were mixed and subsequently, incubated for 5 minutes at room temperature. After an interval of 5 minutes, 1 ml of reaction volume, dispensed from each of the test tubes, was then mixed with 13 ml of culturing medium agar. Such suspensions were used for plating in plates (such as Petri plates), and the plates were then incubated for 48 hours at 35° C. to allow colony formation. Subsequently, total number of colonies formed on each plate were counted and recorded.

In accordance with example 1, compositions (percent by weight) with regard to ingredients of the exemplary antimicrobial compositions 1A, 1B, 1C and 1D are provided in Table 1.

TABLE 1

Composition of
Antimicrobial Composition
(Percentage by weight (%))

| Ingredients | 1A | 1B | 1C | 1D |
|---|---|---|---|---|
| BZK | — | 0.13 | 0.13 | 0.13* |
| Ammonium Lauryl Sulfate | — | — | 1.0 | 1.0 |
| Olive oil | — | — | 4.0 | 4.0 |
| (Source of fatty acids) | | | | |
| Dimethicone | — | — | 1.0 | 1.0 |
| Polyolprepolymer | 2.0 | — | 2.0 | 2.0 |
| SXS | 2.5 | — | — | 2.5 |
| Propylene Glycol | 2.0 | — | — | — |
| Sterile Water | 93.5 | 99.84 | 91.84 | 89.34 |

*BZK dissolved in SXS

Results for experiments conducted for comparing the antimicrobial activities of the exemplary antimicrobial compositions 1A, 1B, 1C and 1D on the E. coli cells after an incubation of 5 minutes at room temperature are shown in Table 2. The experiments were conducted either in replicates or quadruplets and average of percentage killing of microbial cells was calculated, and is provided in Table 2 below.

TABLE 2

| | Percentage Killing (%) |
|---|---|
| Antimicrobial Composition | (5 Minutes' Time Kill) |
| 1A | 8.8 |
| 1B | 68 |
| 1C | 98 |
| 1D | 12 |

From Table 2, with respect to experiments involving the use of the exemplary antimicrobial compositions 1A, 1B, 1C, and 1D, it may be seen that use of polyolprepolymer in 1C alone had increased the efficacy of the exemplary antimicrobial composition. Further, it was noticed that polyolprepolymer prevented crystallization of the exemplary antimicrobial composition 1C.

### EXAMPLE 2

Another set of experiments was conducted to test the microbicidal activity of four exemplary antimicrobial compositions, referred to as “1E”, “1F”, “1G” and “1H” on E. coli cells. Further, the methodology used for conducting the experiments in Example 1 was followed to test the respective microbicidal activities of the exemplary antimicrobial compositions 1E, 1F, 1G and 1H.

In accordance with example 2, compositions with regard to ingredients used in the exemplary antimicrobial compositions 1E, 1F, 1G and 1H are provided in Table 3.

TABLE 3

| | Composition of | | | |
|---|---|---|---|---|
| | Antimicrobial Composition | | | |
| | (Percentage by weight (%)) | | | |
| Ingredients | 1E | 1F | 1G | 1H |
| BZK | 0.13* | 0.13** | 0.13** | 0.13** |
| Ammonium Lauryl Sulfate | 1.0 | 1.0 | 1.0 | 1.0 |
| Olive oil | 4.0 | 4.0 | 4.0 | 4.0 |
| Dimethicone | 1.0 | 1.0 | 1.0 | 1.0 |
| Polyolprepolymer | 2.0 | 2.0 | 2.0 | 2.0 |
| SXS | 10.4 | — | 3.5 | 5.31 |
| Propylene Glycol | — | 7.85 | 5.0 | 9.27 |
| Sterile Water | 81.44 | 83.99 | 83.34 | 87.26 |

*BZK dissolved in SXS
**BZK dissolved in Propylene Glycol

Results for experiments conducted for comparing the antimicrobial activities of the exemplary antimicrobial compositions 1E, 1F, 1G and 1H on the E. coli cells after an incubation of 5 minutes at room temperature are shown in Table 4. The experiments were conducted in replicates and average of percentage killing of microbial cells was calculated.

TABLE 4

| | Percentage Killing (%) |
|---|---|
| Antimicrobial Composition | (5 Minutes' Time Kill) |
| 1E | 62 |
| 1F | 100 |
| 1G | 57.5 |
| 1H | 59 |

From Table 4, with respect to experiments involving the use of the exemplary antimicrobial composition 1F, it may be seen that propylene glycol was the key ingredient responsible for chemical compatibility and increased efficacy with polyolprepolymer. Furthermore, the presence of propylene glycol in 1F showed more than 2 log reduction (approximately) in the E. coli cells after a 5 minutes' incubation at room temperature.

### EXAMPLE 3

A preferred example of the antimicrobial composition of the present invention included about 0.13 percent by weight of BZK and about 1 percent by weight of allantoin. Further, the antimicrobial composition included deionized water, glycerin, cetearyl isononanoate, ceteareth-20, glycerin, cetyl palmitate, cetearyl alcohol, glyceryl stearate, ceteareth-12, propylene glycol, Cocos Nucifera (coconut) oil, sodium hyaluronate, capric acid, cyclohexasiloxane, cyclopentasiloxane, phenoxyethanol, PPG-12/SMDI Copolymer (copolymer of saturated methylene diphenyldiisocyanate and PPG-12 monomers, available from Penederm Incorporated), tocopheryl acetate, dimethicone, disodium EDTA, sodium lauryl sulfate, methyl paraben, tetrahexyldecyl ascorbate, propyl paraben, fragrance and FD&C Blue No. 1.

More specifically, the antimicrobial composition was prepared using the following: phase 1 constituents including, 1 percent by weight of allantoin, 2.50 percent by weight of glyceryl stearate, 4.50 percent by weight of Emulgade® CM (emulsion concentrate of emulsifiers and wax-like constituents; mixture of cetearyl isononanoate, ceteareth-20, cetearyl alcohol, glyceryl stearate, glycerin, ceteareth-12 and cetyl palmitate), 1.0000 percent by weight of phenoxyethanol, 0.2000 percent by weight of propyl paraben, 0.4000 percent by weight of methyl paraben, 1.0000 percent by weight of capric acid, 2.0000 percent by weight of coconut oil and 5.0000 percent by weight of glycerin; phase 2 constituents including, 1.00 percent by weight of Dow Corning® 345 Fluid (cyclomethicone: cyclopentasiloxane and cyclohexasiloxane), 0.99 percent by weight of Trans SF 200, 0.25 percent by weight of BVOSC™ (tetrahexyldecyl ascorbate), 1.00 percent by weight of Vitamin E acetate, 1.00 percent by weight of polyolprepolymer-2 (PPG-12/SMDI copolymer) and 0.010 percent by weight of coconut lemongrass; phase 3 constituents including, 60.840 percent by weight of water, 0.500 percent by weight of disodium EDTA, 4.000 percent by weight of propylene glycol and 0.500 percent by weight of Stepanol® WA Paste (Generic name: Sodium lauryl sulfate); phase 4 constituents including 5.000 percent by weight of water, and 0.160 percent by weight of Hyamine 3500-80 (includes alkyl dimethyl benzyl ammonium chloride in an amount of about 80% percentage by mass) or Stepan's BTC 2125 (50%; benzyl ammonium chloride available from Stepan) Solution; and phase 5 constituents including 5.000 percent by weight of water, 2.00 percent by weight of Hyasol® BT (Hyaluronic Acid Solution-BT) and 0.15 percent by weight of FD&C Blue Solution.

Various experiments were conducted to evaluate microbicidal properties of the above-described preferred example of the antimicrobial composition against various microorganisms, and a description of such experiments is provided below.

A. Assessment of Antiseptic Properties of the Antimicrobial Composition Against E. coli, Staphylococcus aureus and Pseudomonas aeruginosa

Antiseptic properties (antimicrobial effectiveness) of the antimicrobial composition (provided in above-described example 3) of the present invention has been tested against selected microorganisms using standard laboratory techniques. Protocol as described herein was referred from guidelines and procedures described in the “Testing of first aid antiseptic drug products” of the published Tentative Final Monograph for First Aid Antiseptic Drug Products, Federal Register, Volume 56, No. 140, Jul. 22, 1991.

A suspension of selected microbial cells was exposed to the antimicrobial composition for specified time intervals. After exposure, aliquots of the suspension were transferred to a neutralizing medium, properly diluted, and subsequently, incubated and assayed for the percentage of surviving microbial cells. Tests were conducted, aseptically, while avoiding direct exposure to ultraviolet light or sunlight. Bacterial strains, E. coli (ATCC 8739), Staphylococcus aureus (ATCC 6538) and Pseudomonas aeruginosa (ATCC 9027) were obtained from the American Type Culture Collection (ATCC), Manassas, Va.

Reagents used for testing included Soybean-Casein Digest Broth, (Tryptic Soy Broth, BD211825, purchased from Becton, Dickinson and Company (BD) and prepared according to manufactures' instructions); Soybean-Casein Digest Agar (Tryptic Soy Agar, BD236950, purchased from BD and prepared according to the manufactures' instructions); Fetal Bovine Serum (purchased from ATCC and prepared according to the manufactures' instructions); Neutralizing broth (Soybean-Casein Digest Broth containing 0.5% lecithin and 4% (volume/volume) polysorbate-20, as neutralizers); and Phosphate Buffer (Stock Solution, 34.0 g/L monobasic potassium phosphate, i.e., KH₂PO₄). For stock solution of the phosphate buffer, 34.0 grams (g) of KH₂PO₄ was dissolved in 500 ml purified water. Subsequently, pH was adjusted to 7.2 with 1 Normal (N) sodium hydroxide (NaOH) and a final volume of 1000 ml was made using purified water. For working solution of the phosphate buffer, the stock solution was diluted with purified water to the ratio of 1 to 800, and was then sterilized. Test organisms, culturing media, and incubation conditions are listed below in Table 5.

TABLE 5

| Test | ATCC | | Incubation |
|---|---|---|---|
| Organism | Number | Culture Media | conditions |
| E. coli | ATCC 8739 | Soybean-Casein | 32° C., aerobic, 48 |
| | | Digest Agar | hours |
| Staphylococcus | ATCC 6538 | Soybean-Casein | 32° C., aerobic, 48 |
| aureus | | Agar | hours |
| Pseudomonas | ATCC 9027 | Soybean-Casein | 32° C., aerobic, 48 |
| aeruginosa | | Digest Agar | hours |

Test Organism Preparation: 10 ml of Soybean-Casein Digest Broth was inoculated with a stock culture to obtain a bacterial culture. The bacterial culture was incubated for 22-26 hours at 32° C. The bacterial culture was then serially diluted with sterile Soybean-Casein Digest Broth, such that the final cell density was at least 1×10⁹ Colony Forming Unit per milliliter (CFU/ml). The suspension so obtained was used within 2 hours. Alternately, the suspension may be refrigerated and used within 24 hours.

Preparation of Test Substance Samples: The antimicrobial composition (provided in above-described example 3) was prepared using a method known in the art. The antimicrobial composition was used within 2 hours of preparation. An 8.0 ml aliquot of the antimicrobial composition was transferred to a sterile test tube for testing procedures. For the purpose of the description, the antimicrobial composition may hereinafter interchangeably be referred to as “test substance”.

Test and Assay: All test solutions, test substance, and test suspensions were pre-warmed at 32° C. in a water bath for 5 minutes. The reaction temperature was maintained at 32° C. Further, the exposure time used for the assessment of antimicrobial activity was set to be 10 minutes.

Test at the Original Concentration of the Antimicrobial Composition: 1.0 ml of the final bacterial dilution, 1.0 ml of fetal bovine serum, was pipetted into each of sterile test tubes containing 8.0 ml of well-suspended test substance. The content was mixed thoroughly and incubated at 32° C. for exactly the set exposure time. At the end of the incubation interval, 1.0 ml of the reaction mixture, in triplicate, were transferred from each treatment tubes and mixed thoroughly with 9.0 ml of neutralizing broth. Alternately, 0.1 ml of reaction mixture may be mixed with 9.9 ml of neutralizing broth if desirable. Two or more additional 1:10 dilutions were prepared. A 1.0 ml aliquot of the diluted reaction samples was then mixed with molten soybean-casein digest agar for plating.

Test at the 1:120 Dilution of the Antimicrobial Composition: A 1:119 dilution of the test substance with Soybean-Casein Digest Broth (for control, 1 ml of sterile water instead of the test substance was used) was prepared. The final bacterial suspension was diluted to prepare an inoculum of 10⁸ CFU/ml. 1.0 ml of the bacterial inoculum was pipetted into a sterile flask containing 119 ml of the 1:119 diluted test substance. The content was mixed thoroughly and incubated at 32° C. for 48 hours. At the end of the incubation interval, 1.0 ml of the cultured mixture, in triplicate, were transferred and mixed thoroughly with 9.0 ml of Soybean-Casein Digest Broth. Further, 1:10 dilutions of the culture were made. A 1.0 ml aliquot of the diluted samples was then mixed with molten soybean-casein digest agar for plating.

Incubation and Observation: Bacterial subculture plates (i.e. agar plates) were incubated at 32° C. for 48 hours. Colonies on the agar plates were visually examined and enumerated. Total colony counts from replica plates were recorded uniformly and the average number was recorded and calculated as the test data CFU/ml. Log and percentage reductions were determined for each time point. Log and percentage reductions were determined for specified data point using the following formulae:

Percent Reduction=[1−(test data CFU/test population control)]×100.

Log₁₀Reduction=Log₁₀(test population control)−log₁₀(test data CFU)

Test Controls: Controls were included and prepared in the same volume and settings as for the test substance. Test tubes containing 9.9 ml of the phosphate buffer and 0.1 ml of bacterial cells served as the population control. A blank control was prepared that only contained the phosphate buffer.

Table 6, as provided below, depicts results for the above-described test for the antimicrobial composition against Staphylococcus aureus (ATCC 6538).

TABLE 6
ATCC6538

| | Test Tube Identity | | | | | | |
|---|---|---|---|---|---|---|---|
| | Control | Tube 1 | | Tube 2 | | Tube 3 | |
| Sample | — | 100X | 1000X | 100X | 1000X | 100X | 1000X |
| Dilutions | | | | | | | |
| Colony | 136 | 129 | 13 | 140 | 12 | 87 | 10 |
| Count/ | | | | | | | |
| Plate 1 | | | | | | | |
| Colony | 129 | 108 | 17 | 121 | 6 | 115 | 7 |
| Count/ | | | | | | | |
| Plate 2 | | | | | | | |
| Average | 133 | 119 | 15 | 131 | 9 | 101 | 9 |
| Dilution | 10,000,000 | 100 | 1000 | 100 | 1000 | 100 | 1000 |
| Factor* | | | | | | | |
| Inoculum | 1.325E9 | — | — | — | — | — | 8500 |
| (CFU/ml) | | | | | | | |
| Test | 1.325E8 | — | — | — | — | — | — |
| Population | | | | | | | |
| Calculated | — | 12136 | — | 12682 | — | 9955 | — |
| CFU Count | | | | | | | |
| Treatment | — | 99.99084 | — | 99.99043 | — | 99.99249 | — |
| Efficiency | | | | | | | |
| Percentage | — | 99.99084 | — | 99.99043 | — | 99.99249 | — |
| of Dead | | | | | | | |
| Cells (%) | | | | | | | |
| Log Value | 8.122 | 4.084 | — | 4.103 | — | 3.998 | — |
| Log₁₀ | — | 4.038 | — | 4.019 | — | 4.124 | — |
| Reduction | | | | | | | |

*Original 10X included

Table 7, as provided below, depicts results for the above-described tests for the antimicrobial composition against E. coli (ATCC 8739).

TABLE 7
ATCC8739

| | Test Tube Identity | | | | | | |
|---|---|---|---|---|---|---|---|
| | Control | Tube 1 | | Tube 2 | | Tube 3 | |
| Sample | — | 10X | 100X | 10X | 100X | 10X | 100X |
| Dilutions | | | | | | | |
| Colony | 184 | 35 | 3 | 41 | 4 | 33 | 6 |
| Count/ | | | | | | | |
| Colony | 172 | 31 | 5 | 29 | 1 | 40 | 4 |
| Count/ | | | | | | | |
| Average | 178 | 33 | 4 | 35 | 3 | 37 | 5 |
| Dilution | 10,000,000 | 10 | 100 | 10 | 100 | 10 | 100 |
| Factor* | | | | | | | |
| Inoculum | 1.78E9 | — | — | — | — | — | 500 |
| (CFU/ml) | | | | | | | |
| Test | 1.78E8 | — | — | — | — | — | — |
| Population | | | | | | | |
| Calculated | — | 336 | — | 341 | — | 377 | — |
| CFU | | | | | | | |
| Count | | | | | | | |
| CFU After | | 330 | 400 | 350 | 250 | 365 | 500 |
| Treatment | | | | | | | |
| Treatment | — | 99.99981 | — | 99.99981 | — | 99.99979 | — |
| Efficiency | | | | | | | |
| Percentage | — | 99.99981 | — | 99.99981 | — | — | — |
| of Dead | | | | | | | |
| Cells (%) | | | | | | | |
| Log Value | 8.250 | 2.526 | 2.60 | 2.532 | 2.397 | 2.576 | 2.698 |
| Log₁₀ | — | 5.724 | — | 5.718 | — | 5.674 | — |
| Reduction | | | | | | | |

*Original 10X included

Table 8, as provided below, depicts results for the above-described tests for the antimicrobial composition against Pseudomonas aeruginosa (ATCC 9027).

TABLE 8
ATCC9027

| | Test Tube ID | | | | | | |
|---|---|---|---|---|---|---|---|
| | Control | Tube 1 | | Tube 2 | | Tube 3 | |
| Sample | — | 10X | 100X | 10X | 100X | 10X | 100X |
| Dilutions | | | | | | | |
| Colony | 110 | 4 | 0 | 5 | 0 | 6 | 0 |
| Count/ | | | | | | | |
| Colony | 104 | 7 | 0 | 2 | 0 | 8 | 1 |
| Count/ | | | | | | | |
| Average | 107 | 6 | 0 | 4 | 0 | 7 | 1 |
| Dilution | 10,000,000 | 10 | 100 | 10 | 100 | 10 | 100 |
| Factor* | | | | | | | |
| Inoculum | 1.07E9 | — | — | — | — | — | — |
| (CFU/ml) | | | | | | | |
| Test | 1.07E8 | — | — | — | — | — | — |
| Population | | | | | | | |
| Calculated | — | 50 | — | 32 | — | 68 | — |
| CFU Count | | | | | | | |
| Treatment | — | 99.99995 | — | 99.99997 | — | 99.99994 | — |
| Efficiency | | | | | | | |
| Percentage | — | 99.99995 | — | 99.99997 | — | 99.99994 | — |
| of Dead | | | | | | | |
| Cells (%) | | | | | | | |
| Log Value | 8.029 | 1.699 | — | 1.503 | — | 1.834 | — |
| Log₁₀ | — | 6.330 | — | 6.527 | — | 6.196 | — |
| Reduction | | | | | | | |

*Original 10X included

It may be seen from Tables 6-8 that the antimicrobial composition demonstrated efficient bactericidal activity when tested in 10 minutes under the above-described conditions against the referenced strains of Staphylococcus aureus ATCC 6538, E. coli ATCC 8739, and Pseudomonas aeruginosa ATCC 9027. The achieved log₁₀ reduction values (average values) of the three strains were: 4.06 (Staphylococcus aureus), 5.705 (E. coli) and 6.351 (Pseudomonas aeruginosa), respectively as shown in Tables 6-8. The required criterion for such test is a 3 log reduction of viable count in 10 minutes. Accordingly, the antimicrobial composition exhibited effective antiseptic properties against the aforementioned microorganisms.

Further, tests (hereinafter referred to as “validation tests”) were conducted to validate effect of the combined neutralizers, 4% polysorbate and 0.5% lecithin, as described above, according to the U.S. Food and Drug Administration's (FDA) guidelines. The parameters under investigation included neutralizer effectiveness against the test substance and neutralizer toxicity towards to the viability of the testing microorganisms.

Test Culture Preparation for Validation Tests: Stock cultures of test organisms were incubated in Medium A (Soybean-Casein Broth), and were transferred daily in fresh medium for 4 consecutive times before being used for testing.

b 10-minutes Contact Test: Prior to the start of the validation tests, all test solutions were incubated in a water bath at 32° C. for 5 minutes. 1 ml of the serum, 1 ml of test culture and 8 ml of test substance were mixed in a test tube and incubated in a water bath at 32° C. for 10 minutes. Immediately after the 10-minutes interval, triplicate 1-ml aliquots of the above mixture were dispatched into fresh Medium A containing 4% polysorbate 20, and 0.5% lecithin, and serially diluted in the same medium solutions for plating. Bactericidal activities of the test substance were measured by plate-count method on surviving test organisms per milliliter using Medium A agar. As described above, 4.06 log₁₀ reduction of the test culture was achieved for Staphylococcus aureus (ATCC 6538). Tests against E coli and Pseudomonas aeruginosa demonstrated a 5.705, and a 6.351 log₁₀ reductions respectively.

Study Controls: For population control of the test, 8 ml of sterile water was mixed with 1 ml of serum, and 1 ml of the test culture to form an identical 10 ml volume as the test mixture.

Soil Load Test: A soil load test on the fetal bovine serum was conducted to examine the sterility of the test substance. No growth was detected when test substance was incubated in fluid thioglycollate medium at 32° C. for 5 days.

Neutralizer Efficiency Test: Test substance, test culture, and serum were warmed in a water bath at 32° C. for 5 minutes prior to conducting the test. 0.8 milliliter of the test substance, and 9 milliliter of Medium A (Soybean-Casein Digest Broth) containing 4% polysorbate (Spectrum Chemical Corp.) and 0.5% lecithin (Sigma-Aldrich), were mixed in a test tube, followed by adding 0.2 ml of test culture in 50% serum into the test tube. For control tube, 0.8 ml of sterile water was used instead of the test substance. The above mixtures were incubated at 32° C. for 10 minutes, followed by serial dilutions and plating in Medium A agar (Soybean-Casein Digest Agar) containing 4% polysorbate and 0.5% lecithin for surviving bacteria assay. The same test was performed against each of the three bacterial strains.

Neutralizer Toxicity Test: 0.2 milliliter of test culture containing 50% serum was mixed with 9.8 ml of Medium A containing 4% polysorbate and 0.5% lecithin in a test tube. After incubation at 32° C. for 5 minutes, aliquots of the reaction mixture were diluted serially by transferring 1 ml into 9 ml of diluting fluid 1 followed by plating in Medium A agar containing 4% polysorbate and 0.5% lecithin for viable bacteria count assay. For control, 0.2 ml of the same test culture was mixed with Medium A without the neutralizers, incubated, and followed by serial dilutions in diluting fluid and plating in Medium A agar without 4% polysorbate and 0.5% lecithin for the same viable bacteria count assay. The same test was performed against each of the three bacterial strains.

Tables 9 and 10 show the results from two independent Neutralizer Efficiency Tests and Neutralizer Toxicity Tests. For Neutralizer Efficiency Tests (hereinafter interchangeably referred to as “V-I” tests), test set-up included 0.8 ml of test substance, 9 ml N-medium, 0.1 ml cell and 0.1 ml serum for test sample; and 0.8 ml sterile water, 9 ml N-medium, 0.1 ml cell and 0.1 ml serum for control sample. For Neutralizer Toxicity Tests (hereinafter interchangeably referred to as “V-II” tests), test set-up included 0.1 ml cell, 0.1 ml serum, 9.8 ml medium containing N for test sample; and 0.1 ml cell, 0.1 ml serum and 9.8 ml medium for control sample.

TABLE 9

| | | Colony Count | | | | | |
|---|---|---|---|---|---|---|---|
| | | Plate | Plate | Plate | | Dilution | Recovery |
| Sample ID | | 1 | 2 | 3 | Average | Factor* | Rate |
| 6538 | Control | 75 | 58 | 75 | 69 | 10,000,000 | — |
| V-I | Test | 59 | 65 | 60 | 61 | 10,000,000 | 88.46 |
| Test | Sample | | | | | | |
| 6538 | Control | 88 | 92 | 73 | 84 | 10,000,000 | — |
| V-II | Test | 71 | 95 | 69 | 78 | 10,000,000 | 92.89 |
| Test | Sample | | | | | | |
| 8739 | Control | 96 | 84 | 94 | 91 | 10,000,000 | — |
| V-I | Test | 84 | 74 | 87 | 82 | 10,000,000 | 89.42 |
| Test | Sample | | | | | | |
| 8739 | Control | 134 | 117 | 102 | 118 | 10,000,000 | — |
| V-II | Test | 100 | 126 | 123 | 116 | 10,000,000 | 98.87 |
| Test | Sample | | | | | | |
| 9027 | Control | 85 | 92 | 110 | 96 | 10,000,000 | — |
| V-I | Test | 101 | 85 | 80 | 89 | 10,000,000 | 92.68 |
| Test | Sample | | | | | | |
| 9027 | Control | 106 | 114 | 96 | 105 | 10,000,000 | — |
| V-II | Test | 115 | 109 | 80 | 101 | 10,000,000 | 96.20 |
| Test | Sample | | | | | | |

*Original 10X included

TABLE 10

| | | Colony Count | | | | | |
|---|---|---|---|---|---|---|---|
| | | Plate | Plate | Plate | | Dilution | Recovery |
| Sample ID | | 1 | 2 | 3 | Average | Factor* | Rate |
| 6538 | Control | 121 | 109 | 98 | 109 | 10,000,000 | — |
| V-I | Test | 93 | 104 | 96 | 98 | 10,000,000 | 89.33 |
| Test | Sample | | | | | | |
| 6538 | Control | 102 | 97 | 79 | 93 | 10,000,000 | — |
| V-II | Test | 104 | 83 | 92 | 93 | 10,000,000 | 100.36 |
| Test | Sample | | | | | | |
| 8739 | Control | 95 | 101 | 87 | 94 | 10,000,000 | — |
| V-I | Test | 85 | 89 | 84 | 86 | 10,000,000 | 91.17 |
| Test | Sample | | | | | | |
| 8739 | Control | 60 | 87 | 92 | 80 | 10,000,000 | — |
| V-II | Test | 54 | 91 | 89 | 78 | 10,000,000 | 97.91 |
| Test | Sample | | | | | | |
| 9027 | Control | 97 | 121 | 75 | 98 | 10,000,000 | — |
| V-I | Test | 88 | 111 | 66 | 88 | 10,000,000 | 90.44 |
| Test | Sample | | | | | | |
| 9027 | Control | 82 | 114 | 97 | 98 | 10,000,000 | — |
| V-II | Test | 86 | 109 | 99 | 98 | 10,000,000 | 100.34 |
| Test | Sample | | | | | | |

*Original 10X included

It may be seen from Tables 9 and 10 that the combined neutralizers (4% polysorbate and 0.5% lecithin) are efficient for neutralizing the antiseptic (antibacterial activity) of the antimicrobial composition, when present in diluting fluid and in plating medium. The accepting criteria of such a validation test are less than 20% of viable count differences between test and control cultures. Further, presence of the aforementioned neutralizers at working concentrations thereof, during the dilution and plate incubating periods, is incapable of affecting the determination accuracy of viable cell number for the assessment of the antiseptic properties of the antimicrobial composition.

B. Assessment of Antiseptic Properties of the Antimicrobial Composition Against Mycobacterium fortuitum

Antiseptic Properties (antimicrobial effectiveness) of three different test substance samples (referred to as “test substance A,” “test substance B” and “test substance C”) were tested against Mycobacterium fortuitum using standard laboratory techniques, as described below.

Test substance A included PP-2 in an amount of 2 percent by weight, propylene glycol in an amount of 10 percent by weight, SLS in an amount of 0.300 percent by weight of the total weight. Test substance B included PP-2 in an amount of 1 percent by weight, propylene glycol in an amount of 4 percent by weight, SLS in an amount of 0.200 percent by weight of the total weight. Test substance C included PP-2 in an amount of 1 percent by weight, propylene glycol in an amount of 4 percent by weight, SLS in an amount of 0.100 percent by weight of the total weight. All the test substances A, B and C included other ingredients as described above for the antimicrobial composition of example 3.

A suspension of selected microbial cells was exposed to the test substances for specified time intervals. After exposure, aliquots of the suspension were transferred to a neutralizing medium, properly diluted, and subsequently incubated and assayed for the percentage of surviving cells. The tests were conducted, aseptically, while avoiding direct exposure to ultraviolet light or sunlight during the tests. The testing bacterial strain Mycobacterium fortuitum (ATCC 49403) was obtained from the American Type Culture Collection (ATCC), Manassas, Va.

Reagents used for testing included Bacto Brain Heart Infusion (BD237400, purchased from BD and prepared according to the manufactures' instructions); Bacto Brain Heart Infusion Agar (BD236950, purchased from BD and prepared according to the manufactures' instructions); Fetal Bovine Serum (purchased from ATCC and prepared according to the manufactures' instructions); Neutralizing broth: Bacto Brain Heart Infusion; and Phosphate Buffer (Stock Solution, 34.0 g/L monobasic potassium phosphate KH₂PO₄. For the stock solution of the phosphate buffer, 34.0 g of KH₂PO₄ was dissolved in 500 ml purified water. Subsequently, pH was adjusted to 7.2 with 1N NaOH and final volume of 1000 ml was made with purified water. For working solution, the stock solution was diluted with purified water to the ratio of 1 to 800 and sterilized. Test organisms, culturing media, and incubation conditions are listed below in Table 11.

TABLE 11

| Test | | | Incubation |
|---|---|---|---|
| Organism | ATCC Number | Culture Media | Conditions |
| Mycobacterium | ATCC 49403 | Bacto Brain Heart | 37° C., aerobic, |
| fortuitum | | Infusion Agar | 120 hours |

Test Organism Preparation: 10 ml of Brain Heart Infusion Broth was inoculated with a stock culture to obtain a bacterial culture. The bacterial culture was incubated for 5-7 days at 37° C. Alternatively, the bacterium may be inoculated on a Brain Heart Infusion Agar slant. The cultured cells were diluted with sterile Brain Heart Infusion Broth serially such that the final cell density is at least 1×10⁹ CFU/ml. The suspension was used within 2 hours. Alternately, the suspension may be refrigerated and used within 24 hours.

Preparation of Test Substance Samples: Three test substances, A, B and C, as used herein, were prepared using a method known in the art. The test substances were used within 2 hours of preparation. A 9.9 ml aliquot from each of the test substances was transferred to a sterile test tube for testing procedures.

Test and Assay: All test solutions, test substances, and test suspensions were pre-warmed at 32° C. in a water bath for 5 minutes. The reaction temperature was maintained at 32° C. Further, the exposure time used for the assessment of activity of the test substances was set to be 10, 30, 60 and 1080 minutes.

Test at the Original Concentration of each Test Substance): 0.1 ml of the final bacterial dilution was pipetted, into each of sterile test tubes containing 9.9 ml of well-suspended test substance. The content was mixed thoroughly and incubated at 32° C. for exactly the set exposure time. At the end of the incubation interval, 1.0 ml of the reaction mixture, in triplicate, were transferred from each treatment tubes and mixed thoroughly with 9.0 ml of neutralizing broth. Alternately, 0.1 ml of reaction mixture may be mixed with 9.9 ml of neutralizing broth if desirable. Two or more additional 1:10 dilutions were prepared. A 1.0 ml aliquot of the diluted reaction samples was then mixed with molten Brain Heart Infusion agar for plating.

Incubation and Observation: All bacterial subculture plates were incubated at 37° C. for 4-5 days. Colonies on the agar plates were visually examined and enumerated. Total colony counts from replica plates were recorded uniformly and the average number was recorded and calculated as the test data CFU/mL. Log and percentage reductions were determined for each time point.

Test Controls: Controls were included and conducted in the same volume and settings as performed in the sample test. Test tubes containing 9.9 ml of phosphate buffer and 0.1 ml of test cells served as the population control. A blank control was prepared that only contained the phosphate buffer.

Tables 12A and 12B, as provided below, depict results for the above-described test for the three test substances against Mycobacterium fortuitum (ATCC 49403).

TABLE 12A

| | Treatment | Colony Count | | | | |
|---|---|---|---|---|---|---|
| Test | Time | Plate | Plate | | Dilution | Inoculum |
| Substance | (Minutes) | 1 | 2 | Average | Factor | (CFU/ml) |
| Control | | 232 | 229 | 231 | 10000000 | 2.305E9 |
| A | 10 | 111 | 136 | 124 | 2000000 | 2.305E9 |
| | 30 | 46 | 32 | 39 | 2000000 | 2.305E9 |
| | 60 | 9 | 18 | 13.5 | 2000000 | 2.305E9 |
| | Overnight | 0 | 0 | 0 | 2000000 | 2.305E9 |
| B | 10 | 194 | 197 | 195.5 | 2000000 | 2.305E9 |
| | 30 | 46 | 29 | 37.5 | 2000000 | 2.305E9 |
| | 60 | 5 | 6 | 5.5 | 2000000 | 2.305E9 |
| | Overnight | 0 | 0 | 0 | 2000000 | 2.305E9 |
| C | 10 | 88 | 85 | 86.5 | 2000000 | 2.305E9 |
| | 30 | 66 | 77 | 71.5 | 2000000 | 2.305E9 |
| | 60 | 12 | 10 | 11 | 2000000 | 2.305E9 |
| | Overnight | 0 | 0 | 0 | 2000000 | 2.305E9 |

TABLE 12B

| | Treatment | | | Percentage of |
|---|---|---|---|---|
| Test | Time | CFU after | Treatment | Dead Cells |
| Substance | (Minutes) | Treatment | Efficiency | (%) |
| Control | — | — | — | — |
| A | 10 | 2.47E8 | 89.28 | 89.28 |
| | 30 | 7.8E7 | 96.62 | 96.62 |
| | 60 | 2.7E7 | 98.83 | 98.83 |
| | Overnight | 0 | — | >99.8 |
| B | 10 | 3.91E8 | 83.04 | 83.04 |
| | 30 | 7.5E7 | 96.75 | 96.75 |
| | 60 | 1.1E7 | 99.52 | 99.52 |
| | Overnight | 0 | — | >99.8 |
| C | 10 | 1.73E8 | 92.49 | 92.49 |
| | 30 | 1.43E8 | 93.80 | 93.80 |
| | 60 | 2.2E7 | 99.05 | 99.05 |
| | Overnight | 0 | — | >99.8 |

It may be seen from Tables 12A and 12B that the test substances, and more specifically, test substance C, are effective against Mycobacteria fortuitum. Another test substance “D” (including PP-2 in an amount of 1 percent by weight, propylene glycol in an amount of 4 percent by weight, SLS in an amount of 0.500 percent by weight of the total weight) was evaluated using the above-described method. It was observed that the treatment with the test substance D exhibited 99.35% of dead cells after a treatment time of about 30 minutes. Further, a treatment with the test substance D for 60 minutes exhibited 100% of dead cells.

Further, it was observed that efficacy of SLS against various bacterial strains was not inhibited when used in the antimicrobial composition of the present invention.

C. Assessment of Antifungal Properties of the Antimicrobial Composition Against Trichophyton mentagrophytes and Trichophyton ajelloi

Antifungal properties (antimicrobial effectiveness) of the antimicrobial composition (provided in above-described example 3) of the present invention has been tested against Trichophyton mentagrophytes ATCC 9533 (obtained from the American Type Culture Collection (ATCC), Manassas, Va.). Test set-up was the same as followed for testing the antiseptic activity against E. coli, in terms of dilutions and such similar test set-up conditions. However, Fungus Selection Agar was used as the culture media. More specifically, Fungus Selection Agar was inoculated with a stock culture to obtain a culture that was incubated and cultured for 7 days. It was observed that treatment of Trichophyton mentagrophytes with the antimicrobial composition exhibited a log₁₀ reduction value ranging from about 4.2 to about 4.8, thereby, proving potential effectiveness of the antimicrobial composition against fungal microorganisms. Further, it was observed that efficacy of SLS was not inhibited when used in the antimicrobial composition of the present invention.

Antifungal properties (antimicrobial effectiveness) of two different test samples/substances of the antimicrobial composition of the present invention have been tested against Trichophyton ajelloi ATCC 22398 (obtained from the American Type Culture Collection (ATCC), Manassas, Vir.). Test substances 1 and 2, as used herein, referred to the antimicrobial composition (provided in above-described example 3), which were prepared using a method known in the art. Specifically, the test substance 1 included 0.5% of SLS and the test substance 2 included 0.025% of SLS. Test set-up was the same as followed for testing the antiseptic activity against E. coli, in terms of dilutions and such similar test set-up conditions. However, an appropriate agar, such as Fungus Selection Agar, was used as the culture media and the incubation time was set to be as 144 hours with an incubation temperature set to about 24° C. More specifically, Fungus Selection Agar was inoculated with a stock culture to obtain a culture that was incubated and cultured for 144 hours. Table 13, as provided below, depicts results for the above-described test for the two test substances against Trichophyton ajelloi (ATCC 22398).

TABLE 13

| | Sample | | | | |
|---|---|---|---|---|---|
| | Control | Test Substance 1 | | Test Substance 2 | |
| Treatment time | — | 10 | 30 | 10 | 30 |
| (minutes) | | minutes | minutes | minutes | minutes |
| Colony Count/ | 11-16 | 0 | 0 | 0 | 0 |
| plate | | | | | |
| Average | 14 | 0 | 0 | 0 | 0 |
| Dilution factor | 10000 | 100 | 100 | 100 | 100 |
| Inoculum | 135000 | 135000 | 135000 | 135000 | 135000 |
| (CFU/ml) | | | | | |
| Test Population | 13500 | 1350 | 1350 | 1350 | 1350 |
| CFU after | — | 0 | 0 | 0 | 0 |
| treatment | | | | | |
| Treatment | — | 100 | 100 | 100 | 100 |
| efficiency | | | | | |
| Percentage of dead | — | 100 | 100 | 100 | 100 |
| cells (%) | | | | | |
| Log Value | 5.130333 | — | — | — | — |
| Log Reduction | — | >3.11 | — | >3.11 | — |
| (10′) | | | | | |
| Log Reduction | — | — | >3.11 | — | >3.11 |
| (30′) | | | | | |

From Table 13, it was observed that treatment of Trichophyton ajelloi with the test substances 1 and 2 exhibited a log₁₀ reduction value greater than about 3.11, thereby, proving potential effectiveness of the test substances 1 and 2 against fungal microorganisms.

### D. Assessment of Antiviral Properties of the Antimicrobial Composition Against Simian Virus 40

Tests were conducted for evaluating antiviral properties of the antimicrobial composition, such as the antimicrobial composition provided in the above-described example 3, of the present invention against Simian Virus 40 (SV40) when exposed (in suspension) for a specified exposure period(s). SV40 is a surrogate virus for Papillomavirus. In-vitro virucidal suspension assay was designed to evaluate the antiviral properties of the antimicrobial composition against SV40. The presence of virus (infectivity) was determined by monitoring the virus specific Cyto Pathic Effect (CPE) on an appropriate host cell line, Monkey African green kidney epithelial (BS-C-1) cell line (ATCC CCL-26). The host cell line chosen was capable of supporting the growth of SV40. Further, two test samples/substances of the antimicrobial composition of the present invention were selected for the assessment of the antiviral properties of the antimicrobial composition of the present invention.

A suspension of virus was exposed to usual dilution of test substances 1 and 2. At each pre-determined exposure time an aliquot was removed, neutralized by serial dilution, and assayed for the presence of virus. Specifically, 1 ml of volumes of the test substances 1 and 2 were used for plating per well. The positive virus controls, cytotoxicity controls, and neutralization controls were assayed in parallel. Antiviral properties of the test substances 1 and 2 were evaluated and compared at the specified concentrations and time intervals.

Stock Virus: PML-1 EK strain of SV40 stock virus was obtained from the American Type Culture Collection, Manassas, Vir. (ATCC VR-820). The stock virus was prepared by collecting supernatant culture fluid from 75-100% infected culture cells. The cells were disrupted and cell debris was removed by centrifugation. The supernatant was removed, aliquoted, and the high titer stock virus was stored at −70° C. until the day of use. On the day of use, the appropriate number of aliquots of virus were removed, thawed, combined (if applicable) and maintained at a refrigerated temperature until used in the assay.

Cell Cultures and Test Medium: Cultures of the BS-C-1 cell line were maintained and used in tissue culture lab ware at 36-38° C. Minimum Essential Medium (MEM) supplemented with 1-10% (v/v) heat inactivated Fetal Bovine Serum (FBS) may be used as test medium for the virucidal assays. The test medium may also be supplemented with one or more of the following: 10 g/ml gentamicin, 100 units/ml penicillin, and 2.5 g/ml amphotericin B.

Preparation of Test substances: Test substances 1 and 2, as used herein, referred to the antimicrobial composition (provided in above-described example 3), which were prepared using a method known in the art. Specifically, the test substance 1 included 0.025% of SLS and the test substance 2 included 0.5% of SLS. Further, the test substances 1 and 2 may be equilibriated to the exposure temperature, if applicable.

Treatment of Virus Suspension: A 4.5 ml aliquot of each concentration of the test substances 1 and 2 was dispensed into separate tubes and each was mixed with a 0.5 ml aliquot of the stock virus suspension. The mixtures were vortex mixed for a minimum of 10 seconds and held for the remainder of the specified exposure times at the appropriate temperature. This was considered to be the 10⁻¹ dilution of the virus. Immediately following each exposure time, a 0.1 ml aliquot was removed from each tube and the mixtures were titered by 10-fold serial dilutions (0.1 ml and 0.9 ml test medium) and assayed for the presence of virus. To decrease the cytotoxicity associated with the test substances 1 and 2, the first dilution may be made in fetal bovine serum or other appropriate neutralizer with the remaining dilutions in test medium.

Treatment of Virus Control: A 0.5 ml aliquot of the stock virus Suspension was exposed to a 4.5 ml aliquot of test medium instead of the test substances 1 and 2, and treated as previously described for virus suspension. A virus control was performed for each exposure time tested. All controls employed the neutralizer utilized in the test. The virus control titer was used as a baseline to compare the percent and log reduction of each test parameter following exposure to the test substances 1 and 2.

Cytotoxicity Controls: A 4.5 ml aliquot of each concentration of the test subtances 1 and 2 was mixed with a 0.5 ml aliquot of test medium containing the organic soil load (if applicable) in lieu of virus and treated as previously described. When multiple exposure times were considered, the cytotoxicity control was performed at the longest exposure time. The cytotoxicity of the cell cultures was scored at the same time as virus-test substance and virus control cultures. Cytotoxicity was graded on the basis of cell viability as determined microscopically. Cellular alterations due to toxicity were graded and reported as toxic (T) if greater than or equal to 50% of the monolayer is affected.

Neutralization Controls: Each cytotoxicity control mixture (as described above) was challenged with low titer stock virus to determine the dilution(s) of test substances 1 and 2 at which virucidal activity, if any, was retained. Dilutions that showed virucidal activity were not considered in determining reduction of the virus by the test substances 1 and 2.

Neutralization Test: As previously described, 0.1 ml of each test substance and control following the exposure time was added to a 0.9 ml aliquot of neutralizer followed immediately by 10-fold serial dilutions in test medium to stop the action of the test substances 1 and 2. To determine effectiveness of the neutralizer in diminishing the virucidal activity of the test substances 1 and 2, as selected for the assay, low titer stock virus was added to each dilution of the test substance-neutralizer mixture. The mixture was assayed for the presence of virus (as described above for the neutralization control).

The BS-C-1 cell line, which exhibited CPE in the presence of SV40, was used as the host cell line in infectivity assays. Cells in multiwell culture dishes/plates were inoculated with 1 ml of the dilutions prepared from the test substances 1 and 2, and control samples. Uninfected host cell cultures (cell controls) were inoculated with test medium alone. The cultures were incubated at 36-38° C. in a humidified atmosphere in sterile disposable cell culture lab ware. The cultures may be scored periodically (for example, for approximately 14-21 days) for the absence or presence of CPE, cytotoxicity and for viability.

Test Criteria: A valid test required that stock virus be recovered from the virus control; that the cell controls be negative for virus; and that negative cultures be viable. Viral and cytotoxicity titers were expressed as −log₁₀ of the 50 percent titration endpoint for infectivity (TCID₅₀) or cytotoxicity (TCD₅₀), respectively, as calculated by the method of Spearman Karber, using the following formulae:

−Log of 1^{st} dilution inoculated−[{(Sum of % mortality at each dilution/100)−0.5}X(Logarithm of dilution)]

Percent (%) Reduction=1−[TCID₅₀ test/TCID₅₀ of the Virus Control] X 100

Log Reduction=TCID₅₀ of the virus control−TCID₅₀ of the test

Tables 14A and 14B depict results for the virucidal time kill test. In Tables 14A and 14B, symbol “+” denotes presence of cytopathic/cytotoxic effect and symbol “0” denotes that cytopathic/cytotoxic effect was not detected.

TABLE 14A

| | | Test exposure time | | | |
|---|---|---|---|---|---|
| | | 10 min | | Cytotoxicity Control | |
| Dilution | Virus | Test | Test | Test | Test |
| (−Log₁₀) | Control | Substance 1 | Substance 2 | Substance 1 | Substance 2 |
| −3 | ++++ | ++++ | ++++ | 0000 | 0000 |
| −4 | ++++ | ++++ | ++++ | 0000 | 0000 |
| −5 | ++++ | ++++ | ++00 | — | — |
| −6 | +++0 | +++0 | +000 | — | — |
| −7 | 000+ | 0000 | 0000 | — | — |
| TCID₅₀ | 6.50 Log₁₀ | 6.25 Log₁₀ | 5.25 Log₁₀ | — | — |
| Log₁₀ | — | 0.25 Log₁₀ | 1.25 Log₁₀ | — | — |
| Reduction | | | | | |
| Percent | — | 43.77 | 94.38 | — | — |
| Reduction (%) | | | | | |

TABLE 14B

| | | | | Cell Control | |
|---|---|---|---|---|---|
| | | Neutralization Control | | (negative control) | |
| Dilution | Virus | Test | Test | Test | Test |
| (−Log₁₀) | Control | Substance 1 | Substance 2 | Substance 1 | Substance 2 |
| −3 | ++++ | ++++ | ++++ | 0000 | 0000 |
| −4 | ++++ | ++++ | ++++ | — | — |
| −5 | ++++ | ++++ | ++++ | — | — |
| −6 | +++0 | +000 | ++++ | — | — |
| −7 | 000+ | +000 | 0000 | — | — |
| TCID₅₀ | 6.50 Log₁₀ | 6.00 Log₁₀ | 6.50 Log₁₀ | — | — |
| Log₁₀ | — | — | — | — | — |
| Reduction | | | | | |
| Percent | — | — | — | — | — |
| Reduction (%) | | | | | |

As observed from Tables 14A and 14B, time-kill suspension test performed for SV40 (ATCC VR-820) showed that the test substance 1 (with 0.025% SLS) was capable of reducing the infectivity of the SV40 to about 0.25 Log₁₀ (with 43.77% reduction), and the test substance 2 (with 0.5% SLS) was capable of reducing the infectivity of the SV40 to about 1.25 Log₁₀ (with 94.38% reduction) following an exposure period of about 10 minutes.

E. Assessment of the Antimicrobial Composition with Regard to Skin Irritation

It has been observed that BZK is a well-known non-corrosive irritant and SLS is corrosive irritant. Further, tests have been conducted for evaluating Trans Epidermal Water Loss (TEWL) and erythema induced by both BZK and SLS. It has been depicted that BZK has shown much less damage to skin barrier function compared to a corresponding concentration of SLS, whilst both have shown a similar degree of erythema. However, skin barrier function affected by the corrosive irritant SLS usually may need a more prolonged recovery time than skin barrier disruption by non-corrosive irritant BZK.

Accordingly, test was conducted to determine the dermal irritation and sensitization potential of the antimicrobial composition (provided in above-described example 3). Subjects included in the test were male and female (non-pregnant and non-lactating) individuals having ages between 18 and 70, with good health, free from any skin diseases and not under the influence of any systemic or topical corticosteroids, anti-inflammatory drugs or antihistamines at the time of the test. The antimicrobial composition was provided as a semi-occlusive type of patch (dressing). The patch having the antimicrobial composition was prepared using techniques known in the art.

Prior to the application of the patch, test area was wiped with 70% isopropyl alcohol and was allowed to dry. The patch was applied to upper back (between scapulae of an individual) and was allowed to remain in direct skin contact for a period of 24 hours (hrs).

Patches were applied to the same test area on alternate days (such as Monday, Wednesday and Friday) for a total number of 9 applications during induction phase (referred to an initial slow phase of a reaction which later accelerates). It should be apparent to a person skilled in the art that the aforementioned patching schedule for application of the patches may be modified based on parameters such as missed visits of an individual and occurrence of holidays. The test areas were graded for dermal irritation 24 hours after removal of the patches by the subjects on every next day of the application (such as Tuesday and Thursday) and 48 hours after removal of the patches on a day, such as Saturday, unless the patching schedule was altered as described above. The test areas were graded according to scoring system provided in Table 13.

TABLE 15

| Score | Dermal Scoring Scale |
|---|---|
| 0 | No visible skin reaction |
| ± | Barely perceptible erythema |
| 1+ | Mild erythema |
| 2+ | Well defined erythema |
| 3+ | Erythema and edema |
| 4+ | Erythema and edema with vesiculation |

Generally and based on the dermal scoring scale, if a score of “2+” reaction or greater occurred, the patch was applied to an adjacent virgin test area (hereinafter referred to as “new test area”). If a score of “2+” reaction or greater occurred on the new test area, the subject was not patched again during the induction phase but was challenged under “Challenge Phase” on an appropriate day. Following approximately a 2-week rest period, the challenge patches were applied to previously untreated test areas on the back. After 24 hours, the patches were removed and the test areas were evaluated for dermal reactions. The test areas were re-evaluated at 48 and 72 hours under the challenge phase.

The test was initiated with 56 subjects. Three subjects discontinued participation for reasons unrelated to the antimicrobial composition. A total of 53 subjects completed the test. Individual dermal scores recorded during the induction and challenge phases are provided in Table 16 for 25 subjects. Remaining subjects exhibited a similar pattern for induction and challenge scores as depicted in Table 16 for 25 subjects. In Table 16, reference to gender of the subjects has been made using designations “M” for males and “F” for females.

TABLE 16

| Subject | | | | | | | | | | | | |
|---|---|---|---|---|---|---|---|---|---|---|---|---|
| Number | | | | | | | | | | Challenge Scores | | |
| (Age: | Induction Scores | | | | | | | | | 24 | 48 | 72 |
| Gender) | 1 | 2 | 3 | 4 | 5 | 6 | 7 | 8 | 9 | hrs | hrs | hrs |
| 1 (58: F) | 0 | 0 | 0 | 0 | 0 | 0 | 0 | 0 | 0 | 0 | 0 | 0 |
| 2 (39: F) | 0 | 0 | 0 | 0 | 0 | 0 | 0 | 0 | 0 | 0 | 0 | 0 |
| 3 (28: F) | 0 | 0 | ± | ± | 0 | 0 | 0 | 0 | 0 | 0 | 0 | 0 |
| 4 (48: F) | 0 | 0 | 0 | 0 | 0 | 0 | 0 | 0 | 0 | 0 | 0 | 0 |
| 5 (50: F) | 0 | 0 | 0 | 0 | 0 | 0 | 0 | 0 | 0 | 0 | 0 | 0 |
| 6 (40: F) | 0 | 0 | 0 | 0 | 0 | 0 | 0 | 0 | 0 | 0 | 0 | 0 |
| 7 (56: M) | 0 | 0 | 0 | 0 | 0 | 0 | 0 | 0 | 0 | 0 | 0 | 0 |
| 8 (43: F) | 0 | 0 | 0 | 0 | 0 | 0 | 0 | 0 | 0 | 0 | 0 | 0 |
| 9 (35: F) | 0 | 0 | 0 | 0 | 0 | 0 | 0 | 0 | 0 | 0 | 0 | 0 |
| 10 (55: F) | 0 | 0 | 0 | 0 | 0 | 0 | 0 | 0 | 0 | 0 | 0 | 0 |
| 11 (56: F) | 0 | 0 | 0 | 0 | ± | 0 | 0 | 0 | 0 | 0 | 0 | 0 |
| 12 (49: M) | 0 | 0 | 0 | 0 | 0 | 0 | 0 | 0 | 0 | 0 | 0 | 0 |
| 13 (69: M) | 0 | 0 | 0 | 0 | 0 | 0 | 0 | 0 | 0 | 0 | 0 | 0 |
| 14 (54: M) | 0 | 0 | 0 | 0 | 0 | 0 | 0 | 0 | 0 | 0 | 0 | 0 |
| 15 (63: F) | 0 | 0 | 0 | 0 | 0 | 0 | 0 | 0 | 0 | 0 | 0 | 0 |
| 16 (66: M) | 0 | 0 | 0 | 0 | 0 | 0 | 0 | 0 | 0 | 0 | 0 | 0 |
| 17 (38: F) | 0 | 0 | 0 | 0 | 0 | 0 | 0 | 0 | 0 | 0 | 0 | 0 |
| 18 (55: F) | Discontinued | | | | | | | | | | | |
| 19 (31: F) | 0 | 0 | 0 | 0 | 0 | 0 | 0 | 0 | 0 | 0 | 0 | 0 |
| 20 (57: F) | 0 | 0 | 0 | ± | 0 | 0 | 0 | 0 | 0 | 0 | 0 | 0 |
| 21 (56: F) | 0 | 0 | 0 | 0 | 0 | 0 | 0 | 0 | 0 | 0 | 0 | 0 |
| 22 (63: M) | 0 | 0 | 0 | 0 | 0 | 0 | 0 | 0 | 0 | 0 | 0 | 0 |
| 23 (31: F) | Discontinued | | | | | | | | | | | |
| 24 (46: F) | 0 | 0 | 0 | 0 | 0 | 0 | 0 | 0 | 0 | 0 | 0 | 0 |
| 25 (35: F) | 0 | 0 | 0 | 0 | ± | 0 | 0 | 0 | 0 | 0 | 0 | 0 |

It may be seen from Table 16 that based on the test population of 53 subjects and under the conditions as specified above, the antimicrobial composition was incapable of demonstrating a clinically significant potential for eliciting dermal irritation or sensitization. Specifically, the antimicrobial composition was capable of preventing skin sensitivity with SLS (Stepanol® WA Paste present in the amount of 0.500 percent by weight), due to the presence of PP-2, allantoin and silicone oils.

It is known in the art that SLS shows complete inactivation of Human Papilloma Virus (HPV), Herpes Simplex Virus and Human Immunodeficiency Virus at low amounts, such as 0.025%. Further, SLS when used in the antimicrobial composition of the present invention exhibits activity against various viruses, and more specifically, enveloped and non-enveloped viruses. As described before, it was observed that efficacy of SLS was not inhibited when used in the antimicrobial composition of the present invention, based on the tests conducted for determining activity against fungal pathogens and bacterial strains. Therefore, the antimicrobial composition has proved to be effective against viruses, and more specifically, enveloped and non-enveloped viruses. Further, as SV40 has been used as a surrogate for HPV, the antimicrobial composition also exhibited activity against SV40.

The present invention provides an antimicrobial composition that may be used against a wide variety of microorganisms including bacteria, fungi, prions and viruses. The antimicrobial composition serves as an effective guard for damaged and/or undamaged skin, and as an effective guard against infections in whirlpools, patient care or during foot soaks, after shaving one's legs, before and during nail salon treatments, during exposure in gymnasiums and changing/locker rooms, and in other similar situations. Further, the antimicrobial composition is a non-sensitizing and a non-irritating composition.

The antimicrobial composition includes a delivery system (and more specifically, a cutaneous delivery system) that comprises a polyurethane polymer (polyolprepolymer). The delivery system allows various microbiocidal active ingredients of the antimicrobial composition to remain active on skin for an extended period of time. Further, use of polyolprepolymer with a skin protectant helps extending effects of the microbicidal active ingredients of the antimicrobial composition. Specifically, the use of the antimicrobial composition reduces risk for infections on feet at airports, gymnasiums and shoe stores, when used with the skin protectant. Accordingly, the antimicrobial composition may serve as a podiatric product that protects damaged skin and prevents infections in whirlpool or during foot soak. The antimicrobial composition helps in extending microbiocidal persistence while providing good skin compatibility, and helps in protecting a user from side effects of the microbicidal active ingredients.

Use of antiseptics, fatty acids, and other ingredients (such as allantoin), helps in moisturizing and replenishing natural oils lost from skin during activities such as pedicures, manicures and rubbing of skin. Additionally, use of surfactants, skin protectants, polysaccharides, polyurethane polymer and fatty acids, also helps in reducing systemic absorption of the antimicrobial composition and/or components thereof. The antimicrobial composition of the present invention is effective in comparison to hard surface cleaners/disinfectants. Further, the antimicrobial composition has comparable antimicrobial properties as that of iodine-based (0.5% to 5%) disinfectants against bacteria, fungi, mycobacteria, and viruses. However, the use of the antimicrobial composition is advantageous as the iodine-based disinfectants are known to have cosmetic limitations.

Moreover, the antimicrobial composition is capable of treating and preventing infections associated with sexually transmitted diseases. More specifically, the antimicrobial composition is compatible with latex material such as a material of a glove or a condom. Accordingly, the antimicrobial composition may be used with a condom, specifically for skin areas that are not covered by the condom. The antimicrobial composition is latex compatible and serves as a long-acting microbiocidal formula for use with the condom to reduce transmission of pathogens from skin-to-skin contact where the condom does not cover phallus. With regard to health care, the latex material has limitations dependent on size of a pathogen or if a tear or manufacturing defect exists in the condom. Accordingly, the skin protectant of the antimicrobial composition is helpful for use with such physical barriers.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An antimicrobial composition having a broad-spectrum activity against microorganisms, the antimicrobial composition comprising:
about 0.01 to about 10 percent by weight of a polyurethane polymer of total weight of the antimicrobial composition, the polyurethane polymer selected from the group consisting of polyolprepolymer and β-Cyclodextrin-polyurethane polymer;
about 0.01 to about 5 percent by weight of at least one antiseptic agent of the total weight of the antimicrobial composition;
at least one microbicidal agent selected from the group consisting of fatty acids, surfactants; and
a pharmaceutically acceptable excipient system.

2. The antimicrobial composition of claim 1, wherein the polyolprepolymer is selected from the group consisting of polyolprepolymer-2, polyolprepolymer-14 and polyolprepolymer-15.

3. The antimicrobial composition of claim 1, wherein the at least one antiseptic agent is selected from the group consisting of chlorophenols, 2,4-dichlorophenol, p-nitrophenol, picric acid, xylenol, p-chloro-m-xylenol, pyrocatechol, resorcinol, cresols, p-chloro-m-cresol, 4-n-hexyl-resorcinol, pyrogallol, phloroglucin, carvacrol, thymol, p-chlorothymol, o-phenyl phenol, o-benzyl phenol, p-chloro-o-benzyl phenol, phenol, 4-ethylphenol, 4-phenol sulfonic acid, bisguanidines, diphenyl compounds, benzyl alcohols, benzalkonium salts, trihalocarbanilides, quaternary ammonium compounds, ethoxylated phenols, triclosan and heparin.

4. The antimicrobial composition of claim 3, wherein the at least one antiseptic agent is benzalkonium chloride.

5. The antimicrobial composition of claim 1, wherein the fatty acids are selected from the group consisting of medium-chain saturated fatty acids and long-chain unsaturated fatty acids.

6. The antimicrobial composition of claim 5, wherein each fatty acid of the fatty acids is selected from the group consisting of palmitoleic acid, capric acid, caprylic acid, lauric acid, myristic acid, palmitic acid, stearic acid, oleic acid, linoleic acid, linolenic acid, arachidonic acid and monolaurin.

7. The antimicrobial composition of claim 1, wherein the surfactants are selected from the group consisting of cationic surfactants, anionic surfactants, chemical precursors thereof, and combinations thereof.

8. The antimicrobial composition of claim 1, wherein the pharmaceutically acceptable excipient system comprises a solvent selected from the group consisting of water, lower alcohols having one to six carbon atoms, polyols, glycols, sorbitol, and combinations thereof.

9. The antimicrobial composition of claim 8, wherein the pharmaceutically acceptable excipient system comprises about 0.01 to about 30 percent by weight of propylene glycol of the total weight of the antimicrobial composition.

10. The antimicrobial composition of claim 8, wherein the pharmaceutically acceptable excipient system further comprises about 0.01 to about 5 percent by weight of a chelating agent of the total weight of the antimicrobial composition, the chelating agent selected from the group consisting of ethylenediamine tetraacetic acid, citric acid, gluconic acid, B-cyclodextran, hydroxyethylenediamine tetraacetic acid, derivatives, salts and mixtures thereof.

11. The antimicrobial composition of claim 8, wherein the pharmaceutically acceptable excipient system further comprises about 0.01 to about 5 percent by weight of a hydrotrope of the total weight of the antimicrobial composition, the hydrotrope selected from the group consisting of sodium cumene sulfonate, ammonium cumene sulfonate, ammonium xylene sulfonate, potassium toluene sulfonate, sodium toluene sulfonate, sodium xylene sulfonate, toluene sulfonic acid, xylene sulfonic acid, sodium polynaphthalene sulfonate, sodium polystyrene sulfonate, sodium methyl naphthalene sulfonate, sodium camphor sulfonate, and disodium succinate.

12. The antimicrobial composition of claim 8, wherein the pharmaceutically acceptable excipient system further comprises at least one of emollients, tonicity modifiers, thickening agents and gelling agents.

13. The antimicrobial composition of claim 8, wherein the pharmaceutically acceptable excipient system further comprises at least one of buffering agents, pH adjusting agents, emulsifiers and wetting agents.

14. The antimicrobial composition of claim 8, wherein the pharmaceutically acceptable excipient system further comprises a preservative.

15. The antimicrobial composition of claim 1, further comprising about 0.001 to about 1 percent by weight of an essential oil of the total weight of the antimicrobial composition.

16. The antimicrobial composition of claim 1, further comprising about 0.01 to about 5 percent by weight of at least one polysaccharide of the total weight of the antimicrobial composition, the at least one polysaccharide selected from the group consisting of natural polysaccharides and synthetic polysaccharides.

17. The antimicrobial composition of claim 1, further comprising a skin protectant.

18. The antimicrobial composition of claim 17, wherein the skin protectant is silicone oil.

19. The antimicrobial composition of claim 18, wherein the skin protectant is dimethicone.

20. The antimicrobial composition of claim 1, further comprising allantoin.
